(19) United States
(12) Patent Application Publication
(10) Pub. No.: US 2024/0066601 A1
(43) Pub. Date: Feb. 29, 2024

(54) IMPROVED METHOD FOR MANUFACTURING A PART BY ADDITIVE MANUFACTURING

(71) Applicant: SAFRAN, Paris (FR)

(72) Inventors: Mickaël VOIRON, Moissy-Cramayel (FR); Thomas GRICOURT, Moissy-Cramayel (FR); Nicolas OVAERE, Moissy-Cramayel (FR); Matthieu VIAL, Moissy-Cramayel (FR)

(73) Assignee: SAFRAN, Paris (FR)

(21) Appl. No.: 18/261,763

(22) PCT Filed: Jan. 11, 2022
(86) PCT No.: PCT/FR2022/050057

§ 371 Date: Jul. 17, 2023

(30) Foreign Application Priority Data
Jan. 18, 2021 (FR) FR2100451

(51) Int. Cl. B22F 10/80; B22F 10/47; B22F 10/66; B33Y 10/00; B33Y 40/20; B33Y 50/00; F01D 25/16

(52) U.S. Cl. CPC B22F 10/80; B22F 10/47; B22F 10/66; B33Y 10/00; B33Y 40/20; B33Y 50/00; F01D 25/162; B22F 2998/10; F05D 2230/20

(57) ABSTRACT

Method for manufacturing an aeronautical part by additive manufacturing, the part to be manufactured extending around a central axis and comprising at least two walls angled with respect to one another and connected to one another by means of at least one connection section comprised in a connection plane perpendicular to the central axis, the method comprising: providing a digital model of the part to be manufactured, orienting the digital model with respect to a vertical construction direction of the part so that the central axis of the part has an angle β of between 0.1° and 1°; and manufacturing the part by additive manufacturing from the digital model obtained in the orientation step.

### TECHNICAL FIELD

This presentation relates to a method for manufacturing parts by additive manufacturing, allowing in particular to improve the surface condition of the parts obtained. Such an additive manufacturing method is particularly suitable for manufacturing complex parts, intended in particular for the aeronautical field.

### PRIOR ART

It is now known, in the aeronautical field in particular, to use additive manufacturing methods for the production of certain parts whose geometry is fine or complex.

A conventional example of additive manufacturing is manufacturing by melting or sintering powder particles using a high energy beam. Among these high-energy beams, mention may be made in particular of the laser beam and the electron beam.

“Selective Laser Melting” (SLM), also known as the “Laser Beam Melting” (LBM) method, means a method whose main characteristics are recalled below, with reference to FIG. 9 illustrating a conventional device for manufacturing a part by selective melting or selective sintering of powder beds by means of a laser beam.

Is deposited, for example using a spreading tool 120 (for example a roller, or a scraper), a first layer 110a of powder of a material on a construction plate 121 (it may be a plate alone or surmounted by a solid support, a portion of another part or a support grid used to facilitate the construction of certain parts).

This powder is decanted from a supply tray 122 during a forward movement of the roller 120 then it is scraped, and possibly slightly compacted, during one (or more) return movement(s) of the roller 120. The powder is composed of particles 111. The excess powder is collected in a recycling bin 123 located adjacent to the construction bin 124 in which the construction plate 121 moves vertically.

A generator 130 of laser beam 131 is also used, and a steering system 132 capable of directing this beam 131 onto any region of the construction plate 121 so as to scan any region of a layer of powder previously deposited. The shaping of the laser beam 131 and the variation of its diameter on the focal plane are done respectively by means of a beam expander or focusing system 133 and a “Beam Expander” 134, the whole constituting the optical system.

Subsequently, a region of this first layer 110a of powder is brought, by scanning with a laser beam 131, to a temperature above the melting point of this powder.

This type of additive manufacturing method can use any high energy beam instead of the laser beam 131, and in particular an electron beam, as long as this beam is sufficiently energetic to melt the powder particles and part of the material on which the particles rest.

This scanning of the beam is carried out, for example, by a galvanometric head belonging to a control system 132. For example, this control system comprises at least one orientable mirror 135 on which the laser beam 131 is reflected before reaching a layer of powder, each point of the surface of which is always located at the same height with respect to the focusing lens, contained in the focusing system 134, the angular position of this mirror being controlled by a galvanometric head so that the laser beam scans at the least one region of the first powder layer, and thus follows a pre-established part profile. For this purpose, the galvanometric head is controlled according to the information contained in the database of the computer tool used for the computer-aided design and manufacture of the part to be manufactured.

Thus, the powder particles 111 of this region of the first layer 100a are melted and form a first integral element 112a, secured to the construction plate 121. At this stage, it is also possible to scan with the laser beam several independent regions of this first layer to form, after melting and solidification of the material, several first elements 120a disjoint from each other.

The construction plate 121 is lowered by a height corresponding to the thickness of the first layer of powder 110a (20 to 100 μm and in general from 30 to 50 μm).

A second layer 110b of powder is then deposited on the first layer 110a and on this first integral or consolidated element 112a, then a region of the second layer 110b which is located partially or completely above this first integral or consolidated element 112a is heated by exposure to a laser beam 131 in the case illustrated in FIG. 9, such that the powder particles of this region of the second layer 110b are melted with at least a portion of the element 112a and form a second integral or consolidated element 112b, the assembly of these two elements 112a and 112b forming, in the case illustrated in FIG. 9, an integral block.

Such an additive manufacturing technique therefore ensures excellent control of the geometry of the part to be manufactured and allows to produce parts of great complexity.

However, during the production of parts with complex geometry, in particular cylindrical parts such as bearing supports, certain walls of the part are angled with respect to one another, and are connected to one another at a connection zone which is curved, for example into an arc of a circle. Although the connection section between these walls is thin in the radial direction, the surface occupied by this section can be large insofar as it can extend over the entire circumference of the part. However, when the layer allowing to connect these walls together is melted, the connection section ends up in a “downskin” configuration, that is to say momentarily in severe cantilever, or even without any support other than the volume of unsolidified powder located below, and therefore have a risk of subsidence or collapse. This “downskin” configuration also involves parameters different from the parameters used for the previous layers, called standard core layers.

Consequently, at the time of layering, during the passage of the scraper (or roller), the presence of this subsidence involving an irregularity and extending over the entire connection section, creates a “wall” effect causing a slight vibration of the scraper. This vibration can give rise to a jump on the adjacent surface of the part, in particular the outer skin, and therefore to a surface defect. This defect, which can be characterized by 3D optical microscopy, can result in a jump that can reach a height of the order of 250 μm, in the case of a layer thickness of 40 μm.

These defects can be problematic insofar as they are difficult to remove, in particular on the complex surfaces of the parts mentioned above. In addition, they can be the source of local stress concentrations which can be detrimental from the point of view of dimensioning the part.

There is therefore a real need for a method for manufacturing parts by additive manufacturing, allowing to overcome at least some of the aforementioned disadvantages, and thus to improve the surface condition of the parts obtained.

### DISCLOSURE OF THE INVENTION

This presentation relates to a method for manufacturing an aeronautical part by additive manufacturing, the part to be manufactured extending around a central axis and comprising at least two walls angled with respect to one another and connected to one another by means of at least one connection section comprised in a connection plane perpendicular to the central axis, the method comprising:
providing a digital model of the part to be manufactured,
orienting the digital model with respect to a vertical construction direction of the part so that the central axis of the part has an angle β of between 0.1° and 1°, preferably between 0.3° and 0.8° with respect to the construction direction,
manufacturing the part by additive manufacturing on the basis of the digital model obtained at the orientation step.

In the present disclosure, construction direction means the direction in which the part is built, that is to say in which the layers of powder, or manufacturing layers, are stacked on top of each other. For example, when the part is manufactured on a construction plate, the construction direction corresponds to a direction orthogonal to said construction plate, and is therefore vertical.

In addition, in the present description, the terms “axial”, “radial”, “inside”, “outside”, “circumferential” and their derivatives are defined with respect to the central axis of the part. The terms “above” and “below” are understood according to the construction direction.

All the elements constituting the part, in particular the two walls angled with respect to one another, are manufactured in one block and from the same material by additive manufacturing. The “connection section” between the two walls angled with respect to one another is understood as being, during additive manufacturing, the first layer of material allowing to make the junction between these two walls.

In other words, at a layer n of the additive manufacturing, the two walls are spaced apart by a thin gap. The following layer n+1 allows to deposit and merge the material allowing to fill this gap and thus to connect the two walls together. Thus, the connection section is the portion of this layer n+1 allowing to fill this gap existing at the layer n. This connection section therefore extends radially along a dimension corresponding to the width of the gap, and circumferentially around the central axis, when the connection section is curved.

As soon as this connection section is formed at the layer n+1, the subsequent layers are formed integrally, bearing in particular on this connection section, to form the junction zone between the two walls. Nevertheless, the first layer allowing to join these walls, that is to say the connection section, does not rest on any solid layer, other than the volume of non-solidified powder located below.

According to the present presentation, the fact of inclining the central axis of the part by an angle β with respect to the construction direction during the model orientation step also allows to incline by this same angle β the connection plane comprising the connection section. The inclination angles β defined above are sufficient to allow to form the connection section not in one layer, but in several layers, in other words in several passages of the scraper. Preferably, the number of layers necessary to form the connection section is comprised between 10 and 40.

The fact of forming the connection section in several layers allows to limit, at each of these layers, the cantilevered surface or without any support other than the volume of unsolidified powder located below, thus limiting the subsidence phenomenon. Thus, with each passage of the scraper necessary for the formation of the connection section, the cantilevered surface encountered by the scraper will be less, and the vibrations generated on the latter will therefore be limited. Consequently, this inclination allows to limit or even eliminate the presence of a jump on the final part, thus improving the surface condition of the latter.

In some embodiments, the part to be manufactured is axisymmetric around the central axis.

In some embodiments, the connection section extends along an arc of a circle centered around the central axis.

Given this shape, most of the elements constituting the part, in particular the walls angled with respect to one another, are also axisymmetric. Consequently, the connection section between these inclined walls has a circular shape around the central axis of the part. The inclination of the part allows, during manufacture, to form this connection section in several layers, in other words, to close the circular gap existing between the two walls, in several passages of the scraper.

In some embodiments, the step of orienting the digital model comprises adding an inclination wedge to the digital model between a horizontal construction plane and a plane comprising a lower end of the part to be manufactured, so as to incline the central axis by the angle β with respect to the vertical construction direction.

Construction plane means a plane orthogonal to the construction direction and substantially parallel to the construction plate. Inclining the plane comprising the lower end of the part to be manufactured with respect to the horizontal construction plane, by means of the inclination wedge, allows to incline the entire part by an angle β, without changing its geometry.

In some embodiments, the inclination wedge is made of the same material as the part to be manufactured, during additive manufacturing.

In other words, the inclination wedge is an addition of material to the lower end of the part, allowing, during manufacture, to orient the central axis of the part by an angle β with respect to the construction direction. It is therefore possible to improve the surface condition of the final part by simply adding material below the part, without changing its overall geometry.

In some embodiments, the inclination wedge is configured such that, in the plane comprising the lower end of the part to be manufactured, a first radial end of the part to be manufactured has an elevation c with respect to a second radial end opposite the first radial end.

The elevation ε, allowing to incline the part by an angle β, is low, preferably from a few tenths of a millimeter to 20 mm for example. It is therefore possible to improve the surface condition of the final part by simply adding a small amount of material below the part, thus limiting in particular the costs incurred.

In some embodiments, the part to be manufactured comprises a substantially cylindrical outer envelope, the outer envelope comprising the lower end and the first and the second radial end, the first and the second radial end being diametrically opposite one another.

By “substantially cylindrical”, it is understood that the inner envelope has the shape of a cylinder, or a shape similar to that of a cylinder, despite the presence of local irregularities, for example local thinning of its section or the presence of fastening means. It is thus possible to incline the part by the angle β by simply elevating a radial end of the outer envelope by the height ε.

In some embodiments, ε=D×arctan (β), where D is the diameter of the outer envelope of the part to be manufactured.

It is thus possible, for a given value D of diameter of the outer envelope, and therefore of diameter of the part, to determine the elevation value β necessary, to obtain a predetermined inclination β. It will be noted that the angle β can be predetermined according to the number of layers desired, necessary to connect the two walls angled with respect to one another.

In some embodiments, the method comprises, after the manufacturing step, a step of removing the inclination wedge, in which the inclination wedge having been used to incline the part during the manufacture thereof is removed in order to obtain the final part.

The inclination wedge is thus a temporary alteration of the geometry of the part, used only to incline the central axis of the latter during manufacture. The part obtained thus has, once the inclination wedge has been removed, the desired geometry, the surface condition of the final part being moreover improved.

In some embodiments, the removal of the inclination wedge is performed by machining.

In other words, a radial end of the lower end of the part obtained is machined over a height corresponding to the elevation E, to remove the portion corresponding to the inclination wedge, in other words to flatten and level the lower end of the part. In this way, after machining, when the lower end of the part is placed on a horizontal support, the central axis of the part is vertical, and is no longer inclined.

In some embodiments, the part to be manufactured is a turbojet engine bearing support.

### BRIEF DESCRIPTION OF THE DRAWINGS

The invention and its advantages will be better understood upon reading the detailed description given below of various embodiments of the invention given by way of non-limiting examples. This description refers to the pages of appended figures, on which:

FIG. 1 is a side view of a first example of a digital model of a part to be manufactured by the method of the invention,

FIG. 2 is a sectional view of the model of FIG. 1, along a section plane A,

FIG. 3 shows a detailed view of the sectional view of FIG. 2, illustrating a connection section between two inclined walls of the part to be manufactured,

FIGS. 4A and 4B show a top view of the part of FIG. 3, with two successive layers of additive manufacturing,

FIG. 5 shows in a simplified way the model of FIG. 1, during the step of orienting the digital model of the part,

FIGS. 6A to 6D show, in a top view of the part, the formation of a connection section between two inclined walls, at successive layers of additive manufacturing,

FIG. 7 is a diagram showing the different steps of the method of the invention,

FIG. 8 is a side view of a second example of a digital model of a part to be manufactured by the method of the invention,

FIG. 9 shows an overview of an additive manufacturing device by selective melting of powder beds.

### DESCRIPTION OF EMBODIMENTS

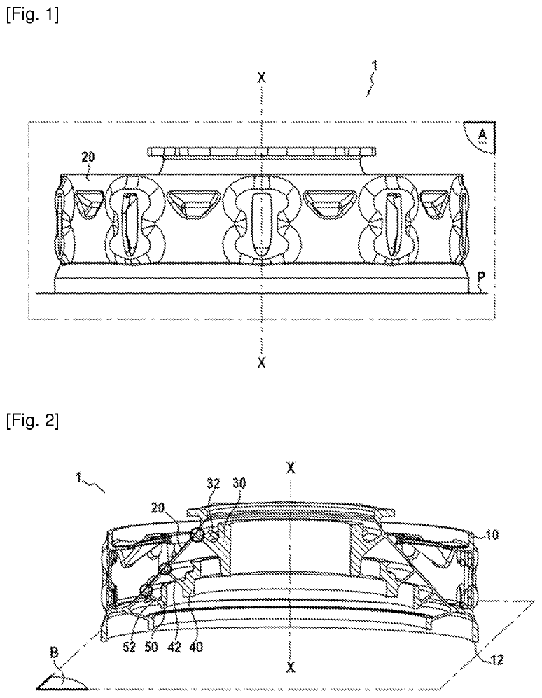

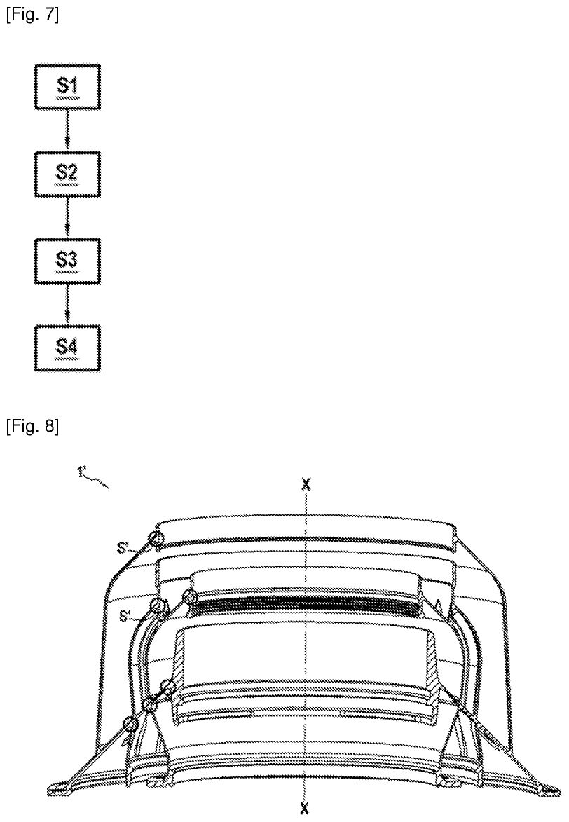

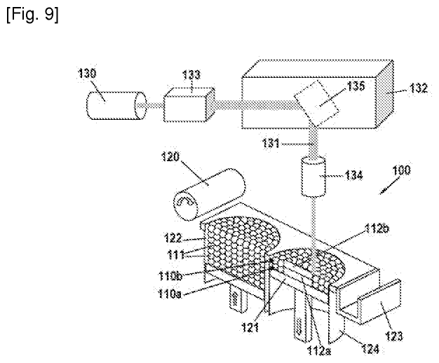

A first example of an embodiment of the invention will be explained in the remainder of the description, with reference to FIGS. 1 to 7. It will be noted that in the remainder of the explanation, the construction direction Z is the direction in which the part is built, that is to say in which the layers of powder, or manufacturing layers, are stacked on top of each other. The construction direction Z is therefore a direction orthogonal to the construction plane P, comprising in particular the construction plate, on which the part is intended to be manufactured. In addition, in the rest of the description, the terms “axial”, “radial”, “lateral”, “inside”, “outside”, “above” or “below” and their derivatives are defined with respect to the central axis X of the part 1 to be manufactured.

In this example, the part to be manufactured is a bearing support, intended to be used in a turbomachine engine, in particular at the engine exhaust case. The turbomachine output bearing support can in particular support the bearing of the rotatable shaft coupling the high pressure compressor and a high pressure turbine. FIG. 1 shows a side view of the part. More specifically, FIG. 1 is a side view of the digital model 1 of the part to be manufactured. In the remainder of the description, for convenience, the digital model of the part will simply be called “part 1”. Part 1 is axisymmetric about a central axis X. The construction plane P corresponds to a horizontal plane, and represents the construction plate on which the part 1 is intended to be manufactured.

A section plane A comprises the central axis X, and is perpendicular to the construction plane P. FIG. 2 shows a sectional side view of the part 1 illustrated in FIG. 1, in the section plane A, allowing to illustrate different elements constituting the part 1. The part 1 comprises in particular a cylindrical, or substantially cylindrical outer envelope 10. A lower end 12 of the outer envelope 10 is comprised in a plane B.

A flange 20, of frustoconical shape, is fastened to the outer envelope 10, inside the latter. The flange 20 is configured to carry, inside the latter, a plurality of support portions 30, 40, 50, each having a cylindrical inner face. The diameters of each of these cylindrical inner faces are different from each other. These support portions 30, 40, 50 are intended to support rolling bearings allowing to guide the shafts of the turbojet engine in rotation.

These support portions 30, 40, 50 are each carried by the flange 20, via a junction portion 32, 42, 52 respectively. It will be noted that each of these elements (the flange 20, the support portions 30, 40, 50, the junction portions 32, 42, 52) is axisymmetric around the central axis X. Each of the junction portions 32, 42, 52 is connected to an inner face of the flange 20 at a connection zone, the connection zones being located by the circles in FIG. 2. The wall of the flange 20 is angled with respect to the central axis X, at an angle of between 40° and 60° for example. The walls of the junction portions 32, 42, 52 are also angled with respect to the central axis X, at an angle opposite to that of the wall of the flange 20, and of between 40° and 60° for example. Thus, each of the junction portions 32, 42, 52 is angled with respect to the wall of the flange 20.

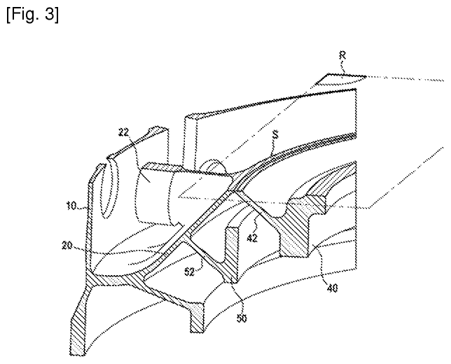

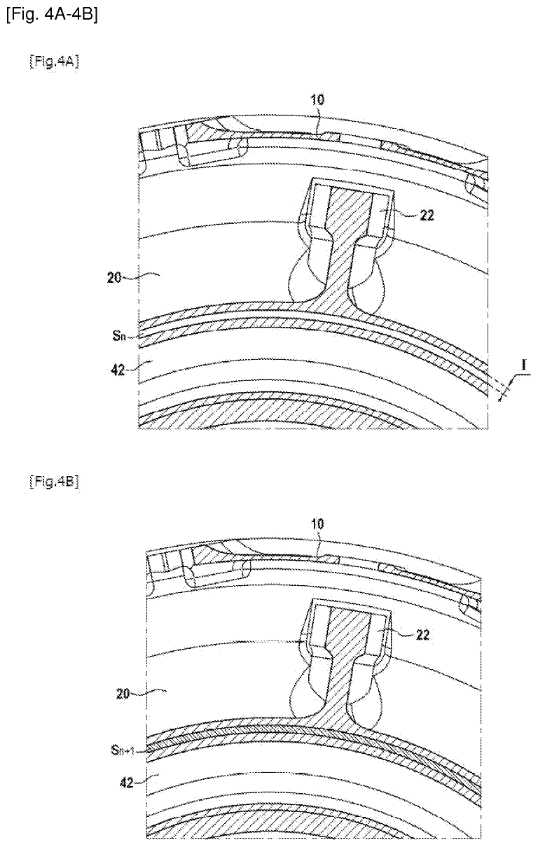

FIG. 3 represents a detailed view of the part of FIG. 2, at the connection between the junction portion 42, and the flange 20. A hollow fastening cylinder 22, allowing to fasten the part 1 to an element of the turbojet engine, is also visible. The view of FIG. 3 shows the part 1 during additive manufacturing, just after the deposition and melting of the layer of powder during which the connection section S is formed. The connection section S is the first layer of material allowing to fill in the gap I existing between the two walls at the previous layer (FIG. 4A) and to make the junction between the junction portion 42 and the flange 20. The connection section S is comprised in a connection plane R perpendicular to the central axis X. Moreover, the connection section S extends in an arc of a circle around the central axis X.

FIG. 4A represents a top view of the section Sn between the junction portion 42 and the flange 20 at a step n, that is to say at a layer n of the additive manufacturing, just before the material allowing to connect said junction portion 42 and said flange 20, is formed. In other words, at this stage, the proper connection section does not yet exist, and the junction portion 42 and said flange 20 are spaced radially by a thin gap I, of between a few hundredths of a millimeter to 1 mm approximately, for example 0.4 mm.

FIG. 4B represents the connection section Sn+1 between the junction portion 42 and the flange 20 at a step n+1, that is to say at a layer n+1 of the additive manufacturing, in which the material for connecting said junction portion 42 and said flange 20 is formed. In the absence of orientation of the model, a single layer is therefore necessary (layer n+1) to close the gap I existing between the junction portion 42 and the flange 20 at the layer n. According to this configuration, the material allowing to close this gap I is not formed on any existing layer, other than the unmelted powder disposed below. In other words, the material of none of the layers formed in the preceding steps allows to support the connection section Sn+1 during its formation. Although the connection section Sn+1 is formed from the same material as the junction portion 42 and said flange 20, the hatchings representing the connection section Sn+1 in FIG. 4B are different from those of the walls 20, 42, indicating the presence of local subsidence on this section.

The method according to the invention described below overcomes this disadvantage.

A first step allows to provide a digital model of the part 1 to be manufactured (step S1), described above. A step of orienting this digital model is then carried out (step S2).

During this step, an inclination wedge 80 is added to the digital model, so as to be disposed, during the manufacture of the part 1, between the horizontal construction plane P, on which the part 1 is manufactured, and the plane B comprising the lower end 12 of the part 1, more precisely of the outer envelope 10. In other words, during manufacture, the lower end 12 of the outer envelope 10 of the part 1 does not rest directly on the construction plane P, given the presence of the inclination wedge 80 inserted between the plane B and the construction plane P.

The inclination wedge 80 comprises a first end 81 intended to rest horizontally on the construction plane P, and a second end 82 angled with respect to the first end 81. The lower end 12 of the outer envelope 10 rests on the second end 82 of the inclination wedge 80, such that the part 1 in turn has an inclination with respect to the construction plane P. Moreover, the outer envelope 10 having a cylindrical shape with an axis X, the inclination wedge 80 in turn has a cylindrical shape with an axis Z, the top of which (the second end 82) is inclined with respect to the base (the first end 81).

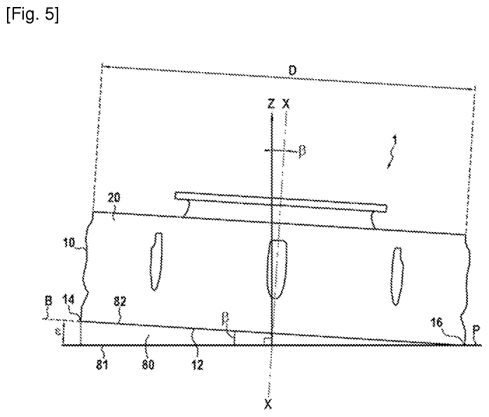

According to a side view of the part 1 (FIG. 5), the inclination wedge 80 has the shape of an inclined ramp. Given this configuration, the presence of the inclination wedge 80 allows to incline the plane B comprising the lower end 12 of the outer envelope 10 of the part 1, by an angle β with respect to the construction plane P. Therefore, the central axis X is also inclined by an angle β with respect to the construction direction Z.

According to this configuration, a first radial end 14 of the part 1, in the plane B comprising the lower end 12, is raised by an elevation height c with respect to a second radial end 16, diametrically opposite the first radial end 14, such that ε=D×arctan (β), where D is the diameter of the outer envelope 10, in particular of the lower end 12 of the part 1 to be manufactured. The angle of inclination β, and the height of elevation c can vary according to the diameter D of the part 1 to be manufactured. For example, for a diameter D of 400 mm, c can be comprised between 0.5 and 5 mm, and β can be comprised between 0.1° and 1°.

After adding the inclination wedge 80 to the digital model, the part 1 is manufactured by additive manufacturing (step S3). More precisely, the inclination wedge 80 is manufactured initially, layer by layer, on the construction plate extending in the construction plane P, and the part 1 is manufactured in the continuity of the inclination wedge 80. In other words, during manufacture, the inclination wedge 80 and the part 1 form one and the same part, and are formed from the same material.

Given the addition of the inclination wedge 80 during step S2, during the manufacture of the wedge/part assembly in the vertical construction direction Z, the central axis X of the part 1 has an angle of inclination 13 with respect to the construction direction Z. Consequently, the aforementioned connection plane R, comprising the connection section S between the junction portion 42 and the flange 20, is also inclined by an angle β with respect to the construction plane P. Thus, the connection between the junction portion 42 and the flange 20 does not take place in one layer, unlike the configuration illustrated in FIGS. 4A and 4B in the absence of an inclination wedge 80, but in several layers. The connection between the junction portion 42 and the flange 20 is therefore progressive.

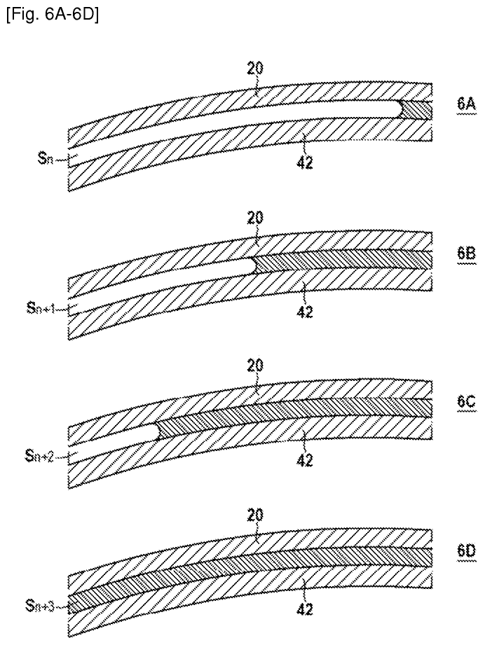

FIGS. 6A to 6D illustrate the formation of the connection section S between the junction portion 42 and the flange 20 during additive manufacturing. Given the inclination of the connection plane R, several layers are necessary to form this connection section S, in other words, to fill the gap I existing between the junction portion 42 and the flange 20 at this stage of the manufacturing of the part 1. FIG. 6A illustrates a connection section Sn at a layer n of the additive manufacturing. FIG. 6B illustrates a connection section Sn+1 at the next layer n+1 of additive manufacturing. Given the inclination of the connection plane R, the portion of the connection section Sn+1 formed at this layer n+1 can be supported, at least in part, on the material already formed during the previous layer n. This allows to limit the phenomenon of subsidence, and therefore the presence of bumps on the final part. Similarly, FIG. 6C illustrates a connection section Sn+2 at the layer n+2, and FIG. 6D illustrates a connection section Sn+3 at the next layer n+3 of additive manufacturing, each surface formed at a layer that can rest on the surface formed in the previous layer.

Preferably, the number of layers necessary to completely form the connection section S is of between 10 and 40. Preferably, the angle of inclination β and the height of elevation c are determined in such a way that the number of layers necessary to completely form the connection section S is comprised in this range.

It will be noted that the above description, with reference to FIGS. 3 to 6D, relates to the connection section S between the junction portion 42 and the flange 20. Nevertheless, this description is of course valid for the other connection surfaces concerned by the problem described, in particular the connection sections S between the junction portion 32 and 52, and the flange 20.

When the manufacture of the part 1 is completed, the inclination wedge 80 having allowed to incline the part 1 during manufacture is removed (step S4). This removal can be carried out by machining, for example, by removing the amount of material corresponding to the dimensions of the inclination wedge 80, thus allowing to obtain the final part 1 having the desired dimensions, and corresponding to the digital model existing before the orientation step S2, in which the inclination wedge 80 had been added.

FIG. 8 shows a digital model of a second example of part 1′ to be manufactured, on which the method according to the invention can be applied. In this example, the part 1′ to be manufactured is an SP5 NMA type bearing support, intended for use in a turbojet engine, in particular at the exhaust case of an engine of the UHBR DD (“Ultra High Bypass Ratio Direct Drive”). The connection zones between walls angled with respect to one another, and involving the same problems as part 1 of the first example, are located by circles in FIG. 8, and the corresponding connection sections S′ are also indicated.

Although the present invention has been described with reference to specific embodiments, it is obvious that modifications and changes can be made to these examples without departing from the general scope of the invention as defined by the claims. In particular, individual features of the different illustrated/mentioned embodiments can be combined in additional embodiments. Accordingly, the description and the drawings should be considered in an illustrative rather than restrictive sense.

1. A method for manufacturing an aeronautical part by additive manufacturing, the part to be manufactured extending around a central axis and comprising at least two walls angled with respect to one another and connected to one another by means of at least one connection section comprised in a connection plane perpendicular to the central axis, the method comprising:
providing a digital model of the part to be manufactured,
orienting the digital model with respect to a vertical construction direction of the part so that the central axis of the part has an angle β of between 0.1° and 1°, preferably between 0.3° and 0.8° with respect to the construction direction,
manufacturing the part by additive manufacturing on the basis of the digital model obtained at the orientation step.

2. The method according to claim 1, wherein the part to be manufactured is axisymmetric around the central axis, and the connection section extends along an arc of a circle centered around the central axis.

3. The method according to claim 1, wherein the step of orienting the digital model comprises adding an inclination wedge to the digital model between a horizontal construction plane and a plane comprising a lower end of the part to be manufactured, so as to incline the central axis by the angle β with respect to the vertical construction direction.

4. The method according to claim 3, wherein the inclination wedge is made of the same material as the part to be manufactured, during additive manufacturing.

5. The method according to claim 3, wherein the inclination wedge is configured such that, in the plane comprising the lower end of the part to be manufactured, a first radial end of the part to be manufactured has an elevation c with respect to a second radial end opposite the first radial end.

6. The method according to claim 5, wherein the part to be manufactured comprises a substantially cylindrical outer envelope, the outer envelope comprising the lower end and the first and the second radial end, the first and the second radial end being diametrically opposite one another.

7. The method according to claim 6, wherein ε=D×arctan (β), where D is the diameter of the outer envelope of the part to be manufactured.

8. The method according to claim 3, comprising, after the manufacturing step, a step of removing the inclination wedge, in which the inclination wedge having been used to incline the part during the manufacture thereof is removed, in order to obtain the final part.

9. The method according to claim 8, wherein the removal of the inclination wedge is performed by machining.

10. The method according to claim 1, wherein the part to be manufactured is a turbojet engine bearing support.
